(19) United States
(12) Patent Application Publication
(10) Pub. No.: US 2011/0287221 A1
(43) Pub. Date: Nov. 24, 2011

(54) MULTILAYER FILM AND A PRODUCTION METHOD FOR SAME

(75) Inventors: Seung-Lac Ma, Chungcheongbuk-do (KR); Dong-Ryul Kim, Daejeon Metropolitan city (KR); Gi-Cheul Kim, Daejeon Metropolitan city (KR); Sang-Uk Ryu, Daejeon Metropolitan city (KR); Ho-Jun Lee, Daejeon Metropolitan city (KR); Eun-Sil Lee, Daejeon Metropolitan city (KR); Jang-Yeon Hwang, Seoul (KR)

(73) Assignee: LG Chem, Ltd., Seoul (KR)

(21) Appl. No.: 13/130,008

(22) PCT Filed: Nov. 19, 2009
(86) PCT No.: PCT/KR2009/006841

§ 371 Date: Aug. 10, 2011

(30) Foreign Application Priority Data
Nov. 19, 2008 (KR) 10-2008-0115391

(51) Int. Cl. B32B 27/08; B32B 27/36; B32B 27/38; C08L 63/06; B05D 3/06; B32B 38/00; C08L 63/00; B32B 27/32; B32B 3/00

(52) U.S. Cl. 428/141; 428/523; 428/480; 428/704; 428/473.5; 428/412; 428/414; 428/335; 427/492; 156/182; 523/400; 977/734

(57) ABSTRACT

Disclosed is a multi-layer film including a polymer substrate and buffer layers formed on the top surface and the bottom surface of the polymer substrate using a UV-cured and thermally cured product of a UV-curable and thermally curable buffer composition. A method for producing the multi-layer film is also disclosed.

### BACKGROUND OF THE INVENTION

The present invention relates to a multi-layer film and a method for producing the same, and more particularly, to a multi-layer film having improved heat resistance and high-temperature flatness and a method for producing the same. This application claims priority under 35 U.S.C. §119 to Korean Patent Application No. 10-2008-0115391, filed on Nov. 19, 2008, with the Korean Intellectual Property Office, the disclosure of which is incorporated herein by reference in its entirety.

In general, glass plates used in various types of electronic devices, including organic or inorganic light emitting devices, display devices and photovoltaic devices, have satisfactory properties in terms of light transmission, heat expansion coefficient and chemical resistance. However, such glass plates are brittle and rigid, and thus require special care when handling them. As a result, limitations are imposed on the design of products using such glass plates.

Due to the above-mentioned problem, many attempts have been made to substitute the use of such glass plates in electronic devices with plastics, which are typically characterized by low weight, excellent impact resistance and high flexibility. However, current commercially available plastic films have several disadvantages when compared to glass plates, and thus there is a need to improve on the physical properties of plastic films. In particular, known plastic films undergo curling, blocking and sagging when processed at temperatures higher than their glass transition temperatures (Tg), and are thus difficult to subject to roll processing.

### SUMMARY OF THE INVENTION

An embodiment of the present invention is directed to providing a multi-layer film having improved heat resistance and high-temperature flatness, thereby facilitating processing carried out at temperatures lower than its glass transition temperature (Tg), and is amenable to processing at temperatures higher than its glass transition temperature (Tg) while inhibiting or completely preventing curling, blocking and sagging phenomena.

Another embodiment of the present invention is directed to providing a method for producing the above-mentioned multi-layer film.

In accordance with an embodiment of the present invention, there is provided a multi-layer film including a polymer substrate and buffer layers formed on the top surface and the bottom surface of the polymer substrate by using a UV-cured and thermally cured product of a UV-curable and thermally curable buffer composition. The polymer substrate may have a monolayer structure or a laminated structure including two or more polymer layers.

In accordance with another embodiment of the present invention, there is provided a method for producing a multi-layer film, including: (a) coating one surface of a polymer substrate with a UV-curable and thermally curable buffer coating composition to form a buffer layer; (b) carrying out UV curing of the buffer layer formed in step (a); (c) coating the other surface of the polymer surface having the buffer layer on one surface thereof with a UV-curable and thermally curable buffer composition to form a buffer layer; (d) carrying out UV curing of the buffer layer formed in step (c); and (e) carrying out thermal curing of the UV-cured buffer layers provided on both surfaces of the polymer surface.

In accordance with another embodiment of the present invention, there is provided a method for producing a multi-layer film, including: (a) coating one surface of a polymer substrate with a UV-curable and thermally curable buffer coating composition to form a buffer layer; (b) carrying out UV curing of the buffer layer; (c) carrying out thermal curing of the UV-cured buffer layer to form a multi-layer film having a structure including the buffer layer laminated with the polymer substrate; (d) repeating steps (a)-(c) to provide another multi-layer film having the same structure as mentioned in step (c); and (e) laminating the multi-layer films obtained in steps (c) and (d) with each other, in such a manner that their polymer substrate surfaces are in contact with each other, to form a multi-layer film having a symmetrical structure.

In accordance with another embodiment of the present invention, there is provided an electronic device including the above-mentioned multi-layer film.

In accordance with another embodiment of the present invention, there is provided a buffer composition used to form the buffer layer, the buffer composition including a sol-like composition of hydrolyzate of at least one of an organosilane and a metal alkoxide, and a curable epoxy resin. In particular, the sol-like composition of hydrolyzate of at least one of an organosilane and a metal alkoxide may be present in an amount of 5-95 parts by weight, and the curable epoxy resin may be present in an amount of 5-95 parts by weight.

### BRIEF DESCRIPTION OF THE DRAWINGS

FIG. 1 is a sectional view of a multi-layer film according to an embodiment of the present invention;

FIG. 2 is a sectional view of a multi-layer film according to another embodiment of the present invention;

FIG. 3 is a graph showing the linear expansion coefficients of the multi-layer films obtained according to Examples 1 and 4 as a function of temperature, in comparison with the multi-layer film obtained according to Comparative Example 3;

FIG. 4 is a photographic view illustrating the multi-layer film having high flatness according to Example 1;

FIG. 5 is a photographic view illustrating the multi-layer film in which curling occurs according to Comparative Example 1; and

FIG. 6 is a photographic view illustrating the multi-layer film having poor flatness according to Comparative Example 3.

### DESCRIPTION OF SPECIFIC EMBODIMENTS

Exemplary embodiments of the present invention will be described below in more detail with reference to the accompanying drawings. The present invention may, however, be embodied in different forms and should not be construed to be limited to the embodiments set forth herein. Rather, these embodiments are provided so that this disclosure will be thorough and complete, and will fully convey the scope of the present invention to those skilled in the art. Throughout the disclosure, like reference numerals refer to like parts throughout the various figures and embodiments of the present invention.

In one aspect, there is provided a multi-layer film including a polymer substrate and buffer layers formed on the top surface and the bottom surface of the polymer substrate using a UV-cured and thermally cured product of a UV-curable and thermally curable buffer composition.

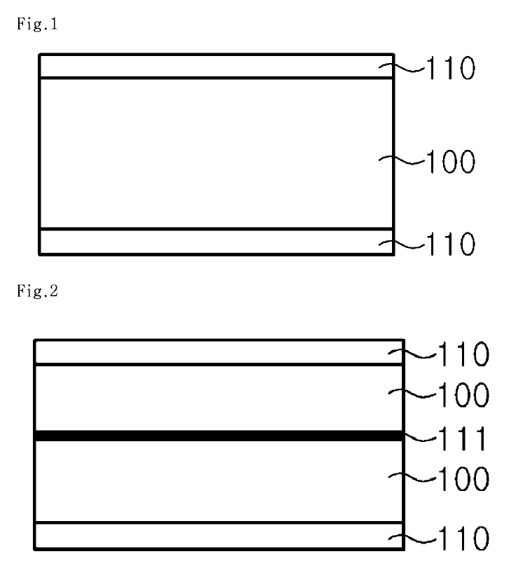

According to an embodiment of the present invention, as shown in FIG. 1, the multi-layer film may have a structure comprising a buffer layer 110, a polymer substrate 100 and another buffer layer 110, stacked successively.

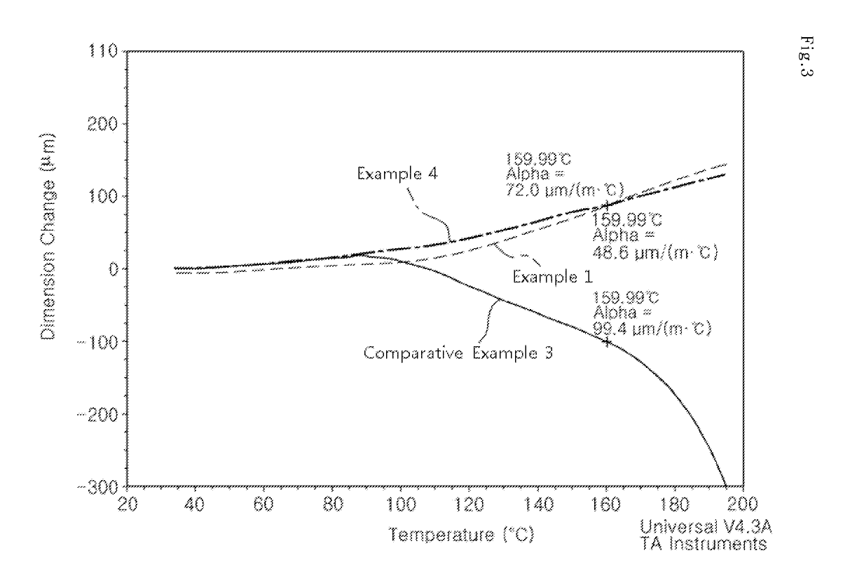

The polymer substrate may have a monolayer structure or a laminated structure comprising two or more layers. FIG. 2 illustrates a structure wherein the polymer substrate includes a polymer substrate 100, a bonding layer 111 and another polymer substrate 100. However, the scope of the present invention is not limited thereto.

The polymer substrate is preferably in the form of a film or sheet having a thickness of 10-2,000 μm.

As mentioned above, the multi-layer film includes a buffer layer subjected to both UV curing treatment and thermal curing treatment. Therefore, it is possible to solve the problems of delamination and curling caused by differential stress between one layer and another layer. As a result, no curling occurs at high temperatures, even in the absence of a known laminated structure. In this context, the polymer substrate may have a monolayer structure. In a variant, the polymer substrate may have a laminated structure comprising two or more polymer layers. When using such a laminated polymer substrate, the resultant multi-layer film has a longitudinally symmetrical structure. As a result, it is possible to minimize curling in the film.

When the polymer substrate has a laminated structure comprising two or more polymer layers, such a laminate may be obtained using a commercially available acrylic adhesive or a thermal bonding process. When using an adhesive, there is no particular limitation in the amount thereof. However, the bonding layer containing an adhesive preferably has a thickness of 0.1-10 μm.

The polymer substrate may be obtained via a solution casting process or film extrusion process. To minimize temperature-dependent deformation after producing the polymer substrate, it is preferred that annealing be carried out at a temperature near the glass transition temperature for a short time of several seconds to minutes. After the annealing, the polymer substrate may be surface treated to improve coatability and adhesiveness. More particularly, such surface treatment may be carried out by primer coating, plasma treatment using corona, oxygen or carbon dioxide, UV-ozone treatment, ion beam treatment using reactive gas, or the like.

The polymer substrate may be at least one selected from substrates formed of a single polymer, substrates formed of a polymer blend including two or more polymers, and substrates formed of a polymer composite to which organic or inorganic additives have been added.

In a preferred embodiment, the multi-layer film may be used as a substrate for a liquid crystal display device. In this case, formation of a thin film transistor and a transparent electrode is carried out at a high temperature of 200° C. or higher. Therefore, it is required to use highly heat-resistant polymers capable of standing such high temperatures. Particular examples of such polymers may include polynorbornene, aromatic fullerene polyester, polyethersulfone, bisphenol A polysulfone, polyimide, etc. More recently, many studies have been conducted to reduce the temperature at which a substrate is processed to a low temperature, so that the processing of a substrate may be performed at low temperatures around 150° C. Therefore, it is possible to use other polymers, such as polyethylene terephthalate, polyethylene naphthalene, polyarylate, polycarbonate, cyclic olefin copolymers, etc.

Particularly, when using a PET film as a substrate, it is possible to inhibit or completely prevent curling, blocking or sagging in the PET film at temperatures higher than the glass transition temperature (Tg). More particularly, when using a PET film, it may be processed at high temperatures of 100° C. or higher to provide a multi-layer film having high surface hardness.

In addition, a polymer composite including a nano-substance comprising an organic or inorganic additive may also be used as the polymer substrate.

The polymer composite may include a polymer-clay nanocomposite including a clay nanosubstance dispersed in a polymer matrix. The polymer-clay nanocomposite may improve the physical properties of a polymer, such as mechanical properties, heat resistance, a gas barrier property and dimensional stability, even with a small amount of clay compared to other known composites including glass fibers, since it includes clay having a small particle size (<1 μm) and high aspect ratio. In other words, it is required to exfoliate layers of laminar clay in order to improve the above-mentioned physical properties, and the above-described polymer-clay nanocomposite satisfies this requirement.

Particular examples of the polymer that may be used in the polymer-clay nanocomposite include polystyrene, polymethacrylate, polyethylene terephthalate, polyethylene naphthalene, polyarylate, polycarbonate, cyclic olefin copolymers, polynorbornene, aromatic fullerene polyester, polyether sulfone, polyimide, epoxy resin, multifunctional acrylate, and the like. Particular examples of clay include laponite, montmorillonite, megadite, and the like.

The buffer layer serves to mitigate the large difference in linear expansion coefficient from the polymer substrate and to improve adhesion to the polymer substrate. In addition, the buffer layer may serve to planarize the surface of the polymer substrate.

More particularly, the buffer layer includes a UV-cured and thermally cured product. After curing, the buffer layer has a content of epoxy groups ranging from 10 wt % to less than 100 wt %, and preferably ranging from 30 wt % to 95 wt %, and more preferably ranging from 50 wt % to 90 wt %.

For example, the buffer layer may include a UV-cured and thermally cured product of a mixture containing hydrolyzate of at least one of an organosilane and a metal alkoxide, and a curable epoxy resin. Preferably, based on 100 parts by weight of the cured product, hydrolyzate of at least one of an organosilane and a metal alkoxide is present in an amount of 5-95 parts by weight, and the curable epoxy resin is present in an amount of 5-95 parts by weight.

The buffer layer may be formed by coating the polymer substrate with a UV-curable and thermally curable buffer composition, followed by UV curing and thermal curing treatment. Particularly, at least one of an organosilane and a metal alkoxide is partially hydrolyzed to obtain a sol-like composition, which, in turn, is mixed with a curable epoxy resin. Then, the polymer substrate is coated with the resultant mixture, followed by UV curing and thermal curing treatment.

Any organosilanes may be used without any particular limitation, as long as they contain organosilane groups. Particularly, at least one organosilane selected from the group consisting of compounds represented by the following Chemical Formulae 1 to 3 may be used. Any metal alkoxides may be used without any particular limitation. Particularly, at least one metal alkoxide selected from the group consisting of compounds represented by the following Chemical Formula 4 may be used. Any curable epoxy resins may be used without any particular limitation as long as they contain epoxy groups. Particularly, at least one epoxy resin selected from the group consisting of alicyclic epoxy resins represented by the following Chemical Formulae 5 to 10 and triglycidyl isocyanurates represented by the following Chemical Formula 11 may be used.

(R¹)ₘ—Si—X₍₄₋ₘ₎ [Chemical Formula 1]

(R¹)ₘ—O—Si—X₍₄₋ₘ₎ [Chemical Formula 2]

(R¹)ₘ—N(R²)—Si—X₍₄₋ₘ₎ [Chemical Formula 3]

wherein X(s) may be the same or different, and each represents H, halogen, a C1-C12 alkoxy, acyloxy, alkylcarbonyl, alkoxycarbonyl or —N(R²)₂;

R¹(s) may be the same or different, and each represents a C1-C12 alkyl, C2-C12 alkenyl, alkynyl, C6-C20 aryl, arylalkyl, alkylaryl, arylalkenyl, alkenylaryl, arylalkynyl, alkynylaryl, halogen, amide, aldehyde, ketone, alkylcarbonyl, carboxy, mercapto, cyano, hydroxyl, C1-C12 alkoxy, C1-C12 alkoxycarbonyl, sulfonic acid, phosphoric acid, acryloxy, methacryloxy, epoxy or vinyl group;

R² is H or C1-C12 alkyl; and

m is an integer of 1-3.

M-(R³)_{z} [Chemical Formula 4]

wherein M is a metal element selected from aluminum, zirconium and titanium;

R³(s) may be the same or different, and each represents halogen, C1-C12 alkyl, alkoxy, acyloxy or hydroxyl group; and

Z is an integer of 3 or 4.

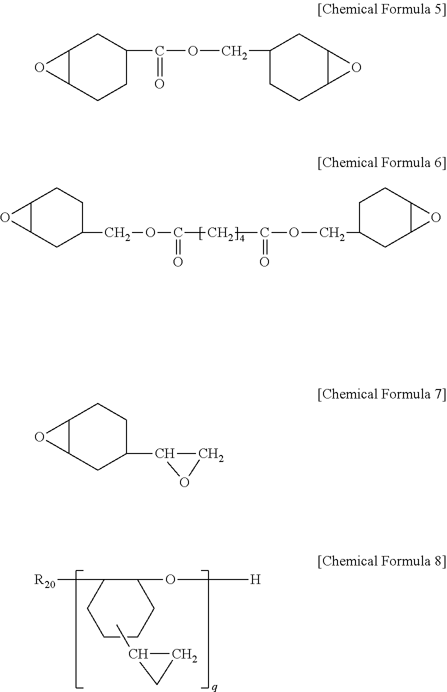

wherein R₂₀ represents alkyl or trimethylolpropane residue, and q is 1-20.

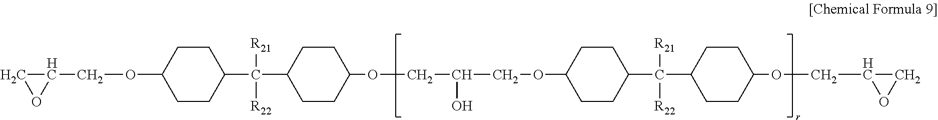

wherein R₂₁ and R₂₂ may be the same or different, and each represents H or CH₃, and r is 0-2.

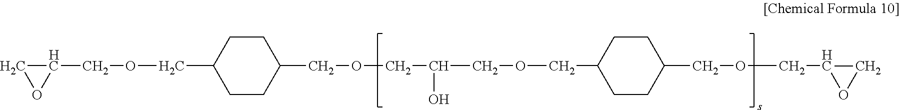

wherein s is 0-2.

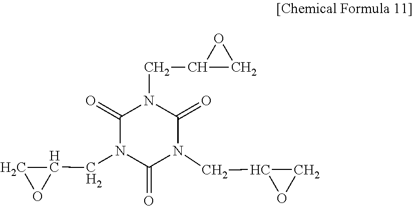

The buffer composition for forming the buffer composition may include organosilane and metal alkoxide, either alone or in combination with each other. The combined amount of organosilane and metal alkoxide is preferably 5-95 parts by weight based on 100 parts by weight of the buffer composition.

The curable epoxy resin may be used in an amount of 5-95 parts by weight based on 100 parts by weight of the buffer composition, and may further include a curing agent in an amount of 1-90 parts by weight based on 100 parts by weight of the buffer composition. In addition, the curable epoxy resin may further include 0.1-20 parts by weight of a catalyst based on 100 parts by weight of the buffer composition.

Preferably, the curable epoxy resin may be prepared by the method including the steps of: mixing 1-90 parts by weight of a curing agent with 0.1-20 parts by weight of a catalyst, based on 100 parts by weight of a buffer composition; and mixing 100 parts by weight of the buffer composition, to which the catalyst is added, with 1-95 parts by weight of an epoxy resin. More preferably, 91 parts by weight of an epoxy curing agent is mixed with 1 part by weight of a catalyst, and the mixture is heated and agitated for 30 minutes. Then, 50 parts by weight of solid epoxy is agitated and melted for 10 minutes, and the catalyst-containing curing agent is mixed with the molten epoxy while being agitated to provide a transparent curable epoxy resin.

As the epoxy resin, the alicyclic epoxy resins represented by the above Chemical Formulae 5-10 and triglycidyl isocyanurate represented by the above Chemical Formula 11 may be used either alone or in combination with each other. In particular, the combination may be formed from two or more epoxy resins and, if desired, by using another epoxy resin to adjust the refractive index so that the combination may have the same refractive index as glass fillers.

Preferred examples of the curing agent include acid anhydride-type curing agents. Examples include at least one curing agent selected from the group consisting of phthalic acid anhydride, maleic acid anhydride, trimellitic acid anhydride, pyromellitic acid anhydride, hexahydrophthalic acid anhydride, tetrahydrophthalic acidic anhydride, methylnadic acid anhydride, nadic acid anhydride, glutaric acid anhydride, methylhexahydrophthalic acid anhydride, methyltetrahydrophthalic acid anhydride, hydrogenated methylnadic acid anhydride and hydrogenated nadic acid anhydride. More particularly, methylhexahydrophthalic acid anhydride and hydrogenated methylnadic acid anhydride are preferred in terms of transparency.

The catalyst is a curing accelerator, and may be at least one catalyst selected from the group consisting of: organic acids as cationic catalysts, including acetic acid, benzoic acid, salicylic acid, para-toluene sulfonic acid, boron trifluoride-amine complex, boron trifluoride ammonium salt, aromatic diazonium salt, aromatic sulfonium salt, aromatic iodonium salt and aluminum complex-containing cationic catalysts; tertiary amines, such as 1,8-diazabicyclo[5.4.0]undecene-7 and triethylene diamine; imidazoles, such as 2-ethyl-4-methylimidazole; phosphorus compounds, such as triphenylphosphine and tetraphenylphosphinium; tetraphenyl borate; quaternary ammonium salt; organometallic salts; and derivatives thereof.

The buffer composition may be prepared from the above-noted compounds, optionally with the addition of fillers and solvents.

The filler may be at least one selected from the group consisting of metal, glass powder, diamond powder, silicon oxide, clay, calcium phosphate, magnesium phosphate, barium sulfate, aluminum trifluoride, calcium silicate, magnesium silicate, barium silicate, barium carbonate, barium hydroxide and aluminum silicate.

There is no particular limitation as to the solvent, as long as the solvent is compatible with or soluble to the epoxy resin, curing agent and catalyst. Particular examples of the solvent include at least one selected from methylene chloride, dichloroethane, dioxane, acetone, methyl ethyl ketone, methyl isobutyl ketone, methanol, ethanol, propanol and isopropanol.

The filler and solvent may be added in a desired amount without any particular limitation.

The formation of a buffer layer using the above-described materials allows the production of a multi-layer film that undergoes minimized deformation when thermally cured, and has a flat surface even at high temperature.

UV curing of the buffer composition is carried out using any method for performing a radical reaction based on a UV light source. Mercury or metal halide lamps may be used alone or in combination with each other. The buffer layer may be imparted with increased surface hardness through the UV curing process.

As described above, buffer compositions on both surfaces of the polymer substrate are UV-cured to increase the surface hardness thereof, and are then subjected to thermal curing to provide a multi-layer film.

The buffer layer serves to alleviate a major difference in linear expansion coefficient from the polymer substrate and to improve the adhesion to the polymer substrate. In addition, the buffer layer may serve to planarize the surface of the polymer substrate.

In another aspect, there is provided a method for producing a multi-layer film, including: (a) coating one surface of a polymer substrate with a UV-curable and thermally curable buffer coating composition to form a buffer layer; (b) carrying out UV curing of the buffer layer formed in step (a); (c) coating the other surface of the polymer surface having the buffer layer on one surface thereof with a UV-curable and thermally curable buffer composition to form a buffer layer; (d) carrying out UV curing of the buffer layer formed in step (c); and (e) carrying out thermal curing of the UV-cured buffer layers provided on both surfaces of the polymer surface.

In another aspect, there is provided a method for producing a multi-layer film, including: (a) coating one surface of a polymer substrate with a UV-curable and thermally curable buffer coating composition to form a buffer layer; (b) carrying out UV curing of the buffer layer; (c) carrying out thermal curing of the UV-cured buffer layer to form a multi-layer film having a structure comprising the buffer layer laminated with the polymer substrate; (d) repeating steps (a)-(c) to provide another multi-layer film having the same structure as mentioned in step (c); and (e) laminating the multi-layer films obtained in steps (c) and (d) with each other, in such a manner that their polymer substrate surfaces are in contact with each other, to form a multi-layer film having a symmetrical structure.

Although there is no particular limitation as to the coating process for the buffer layer, non-limiting examples of the coating process include spin coating, roll coating, bar coating, dip coating, gravure coating and spray coating processes.

The buffer layer formed as described above preferably has a thickness ranging from 0.1-50 μm. When the buffer layer has a thickness less than 0.1 μm, there are problems caused by pinhole defects and current leakage. On the other hand, when the buffer layer has a thickness larger than 50 μm, film deformation may occur during the curing, and surface roughness is formed, thereby degrading flatness.

The surface roughness Ra (average of roughness) of the buffer layer surface is very important. When the buffer layer is not smooth, forming an additional layer on the buffer layer may cause defects.

To solve the above-mentioned problems, the buffer layer preferably has a surface roughness of about 1 nm, more preferably of 1 nm or less. Particularly, the surface roughness Ra may be between 0.1 nm and 1.2 nm.

In the method for producing a multi-layer film, there is no particular limitation as to the UV curing process, as long as the process facilitates a radical reaction using a UV light source. However, mercury or metal halide lamps may be preferably used, either alone or in combination with each other. For example, UV curing may be carried out under an energy dose of 20 mJ/cm² to 3000 mJ/cm² for a period ranging from 1 second to several hours, such as 1 minute or less. Meanwhile, thermal curing may be carried out at a temperature ranging from 100 to 200° C. for a period ranging from 1 minute to several hours, such as 1 hour or less, and preferably 10-20 minutes.

The above-described multi-layer film according to the present invention may be imparted with improved surface hardness in an instant by the UV curing, and shows minimized deformation during the thermal curing, so that it may have a linear expansion coefficient as low as 6.5 ppm/K. The multi-layer film according to the present invention has a linear expansion coefficient of 5-30 ppm/K, and preferably 6-20 ppm/K. In addition, the multi-layer film may have a pencil hardness of 2 or more, preferably of 2H-8H. Therefore, the multi-layer film may substitute for heavy and brittle glass substrates that have traditionally been used in display devices. The multi-layer film may also be used as a material in applications requiring an excellent gas barrier property.

In another aspect, there is provided an electronic device, such as an image display device, including the multi-layer film. The multi-layer film according to the present invention may be used as a substrate material of an image display device or a covering material of a display device.

The electronic device includes the multi-layer film as a substrate, and may be realized using a method generally known to those skilled in the art.

The multi-layer film according to the present invention is imparted with improved surface hardness in an instance by UV curing, shows minimized deformation during thermal curing, and has a flat surface even at high temperatures. Therefore, the multi-layer film may substitute for heavy and brittle glass substrates that have traditionally been used in display devices. The multi-layer film may also be used as a material in some applications requiring excellent heat resistance and high-temperature flatness.

The examples will now be described. The following examples are for illustrative purposes only, and are not intended to limit the scope of the present invention.

### Example 1

First, 20 parts by weight of tetraethoxysilane (TEOS) is mixed with 10 parts by weight of glycidoxypropyltrimethoxysilane (GPTMS). Next, 7 parts by weight of distilled water, 20 parts by weight of ethanol and 0.01 parts by weight of HCl are added thereto, and the resultant mixture is subjected to partial hydrolysis at 25° C. for 24 hours to provide a sol. Then, the resultant sol is mixed with 100 parts by weight of an epoxy compound (Trade name ERL-4221, available from Dow Chemical) and 6 parts by weight of a catalyst, triarylsulfonium hexafluoroantimonate salt mixed 50 wt % in propylene carbonate, to provide an organic/inorganic hybrid buffer composition.

One surface of a PET substrate is bar coated with the buffer composition and the solvent is removed in a convection oven at 90° C. for 5 minutes, followed by UV curing. Then, the remaining uncoated surface of the PET substrate is bar coated with the buffer composition and the solvent is removed in a convection oven at 90° C. for 5 minutes, followed by UV curing. After that, the buffer composition is thermally cured in a convection oven at 180° C. for 1 hour to obtain a PET film coated with the buffer composition on both surfaces thereof.

After the completion of the curing, the buffer layer has a thickness of 10 μm, as measured using an Alpha Stepper. The buffer layer has a surface roughness of 0.4 nm or less per 10 μm×10 μm unit of area, as measured in a tapping mode of AFM (Atomic Force Microscopy) at room temperature.

The PET film obtained as described above is tested to determine its linear expansion coefficient and pencil hardness, which are the main physical properties required of a substrate for display devices. The results are shown in the following Table 1. The PET film itself has a linear expansion coefficient of 22.4 ppm/K. The physical properties are determined as described hereinafter. The same applies to the following Examples and Comparative Examples.

1) Linear Expansion Coefficient: TMA (Thermomechanical Analysis) is used to measure the linear expansion coefficient under a stress of 5 gf at a heating rate of 10° C./minute based on ASTM D696. The linear expansion coefficients of different types of multi-layer films as a function of temperature are shown in FIG. 3.

2) Pencil Hardness: The pencil hardness is measured under a load of 200 g based on ASTM D3363.

Each reported physical property value is the average of at least 5 measurements, and thus is statistically representative and meaningful.

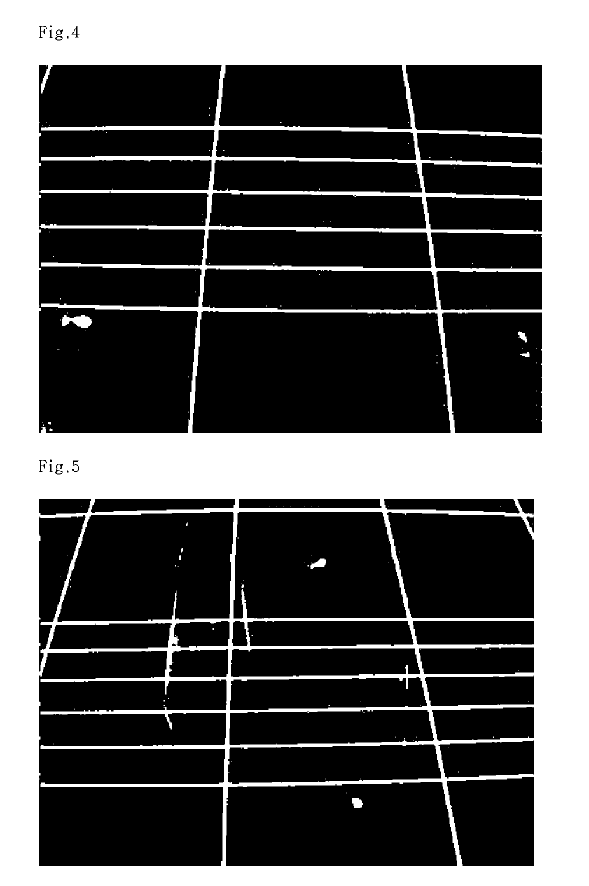

As can be seen from FIG. 4, the substrate according to Example 1 shows no bending when placed on a flat ground. In other words, the substrate according to Example 1 has excellent heat resistance and high-temperature flatness. As shown in Table 1, the plastic substrate obtained according to Example 1 has a small linear expansion coefficient as well as high dimensional stability.

### Example 2

Example 1 is repeated to provide a buffer composition and a film coated therewith, except that 10 parts by weight of an anhydride (MH700G, New Japan Chemical) are further introduced as a curing agent.

### Example 3

Example 1 is repeated to provide a buffer composition and a film coated therewith, except that 80 parts by weight of tetraethoxysilane are mixed with 10 parts by weight of glycidoxypropyltrimethoxysilane, and then 28 parts by weight of distilled water, 80 parts by weight of ethanol and 0.04 parts by weight of HCl are added thereto.

### Example 4

Example 1 is repeated to provide a buffer composition and a film coated therewith, except that 30 parts by weight of colloidal silica (MIBK-ST) are further added.

### Example 5

Example 1 is repeated to provide a buffer composition and a film coated therewith, except that 10 parts by weight of metal alkoxide [Al(OBu)₃] are further introduced, 10 parts by weight of distilled water and 30 parts by weight of ethanol are added, and 30 parts by weight of colloidal silica (MIBK-ST) are further introduced.

### Example 6

First, 20 parts by weight of tetraethoxysilane (TEOS) are mixed with 10 parts by weight of glycidoxypropyltrimethoxysilane (GPTMS). Next, 7 parts by weight of distilled water, 20 parts by weight of ethanol and 0.01 parts by weight of HCl are added thereto, and the resultant mixture is subjected to partial hydrolysis at 25° C. for 24 hours to provide a sol. Then, the resultant sol is mixed with 100 parts by weight of an epoxy compound (Trade name ERL-4221, available from Dow Chemical) and 6 parts by weight of triarylsulfonium hexafluoroantimonate salt mixed 50 wt % in propylene carbonate to provide an organic/inorganic hybrid buffer composition.

One surface of a PET substrate is bar coated with the buffer composition, and the solvent is removed in a convection oven at 90° C. for 5 minutes, followed by UV curing. Then, the buffer composition is thermally cured in a convection oven at 180° C. for 1 hour to obtain a PET film coated with the buffer composition on one surface thereof. The buffer layer has a surface roughness of 0.4 nm or less per 50 μm×50 μm unit of area, as measured in a tapping mode of AFM (Atomic Force Microscopy) at room temperature.

Then, another multi-layer film is obtained in the same manner as described above.

Finally, the remaining uncoated PET surface of the above-described multi-layer film is bar coated with an adhesive composition based on a multi-functional acrylate oligomer. Then, the multi-layer film is laminated with the polymer substrate of the preliminarily formed multi-layer film obtained as described above, and the resultant laminate is subjected to UV irradiation using a DYMAX 2000-EC for 6 minutes to cure the adhesive composition. In this manner, a plastic substrate having a symmetrical structure is obtained. The substrate according to Example 6 shows no bending when placed on a flat ground.

### Comparative Example 1

A buffer composition is obtained in the same manner as described in Example 1, and one surface of a substrate is bar coated therewith. Then, the solvent is removed in a convection oven at 90° C. for 5 minutes. The other surface of the substrate is also bar coated with the buffer composition, and the solvent is removed in a convection oven at 90° C. for 5 minutes. After that, thermal curing is carried out in a convection oven at 200° C. to obtain a film coated with the buffer composition on both surfaces thereof.

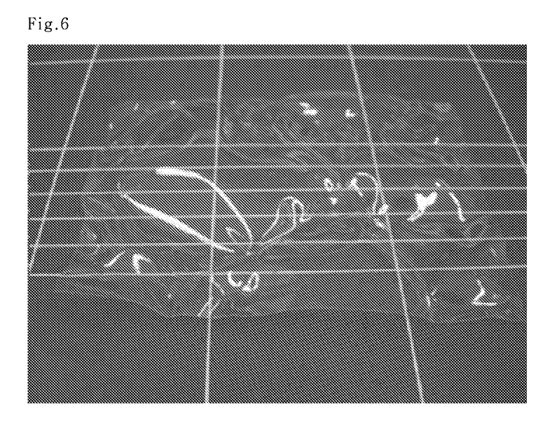

However, thermal curing a film coated on one surface thereof provides a film that does not have a symmetrical structure in the thickness direction. Thus, the film undergoes curling when cured, as can be seen from FIG. 5. In addition, coating the opposite surface after the curing causes blocking of the initially coated surface when the surface is in contact with the ground. Therefore, it is not possible to obtain a clearly coated film.

### Comparative Example 2

A buffer composition is obtained in the same manner as described in Example 1, and one surface of a substrate is bar coated therewith. Then, the solvent is removed in a convection oven at 90° C. for 5 minutes, followed by UV curing. The other surface of the substrate is further bar coated with the buffer composition, and the solvent is removed in a convection oven at 90° C. for 5 minutes, followed by UV curing, to obtain a film coated with the buffer composition on both surfaces thereof (the additional thermal curing step is eliminated).

UV curing alone does not accomplish complete curing. Thus, the film has low interfacial adhesion, resulting in degradation of physical properties such as pencil hardness.

### Comparative Example 3

A PET film not coated with the buffer composition according to Example 1 is tested to determine its physical properties. As can be seen from FIG. 6, the film according to Comparative Example 3 undergoes curling and shows poor high-temperature flatness.

TABLE 1

| | | | Pencil | |
|---|---|---|---|---|
| | | | hardness | |
| | Linear expansion coefficient | | (200 g | |
| | 100° C. or lower | 100-200° C. | load) | Reference |
| Ex. 1 | 12 | 72 | 3H | |
| Ex. 2 | 12 | 65 | 3H | Curing agent |
| | | | | added |
| Ex. 3 | 12 | 66 | 4H | Composition |
| | | | | modified |
| Ex. 4 | 13 | 48 | 4H | Inorganic |
| | | | | material |
| | | | | added |
| Ex. 5 | 13 | 50 | 4H | Metal |
| | | | | catalyst, |
| | | | | inorganic |
| | | | | material |
| | | | | added |
| Comp. Ex. 1 | 13 | 76 | 4B | Thermal |
| | | | | curing alone |
| Comp. Ex. 2 | 15 | 72 | H | UV curing |
| | | | | alone |
| Comp. Ex. 3 | 13 | −99 | H | PET |
| | | | | substrate |
| | | | | itself |

It can be seen from Table 1 that Examples 1-6 according to the present invention have higher pencil hardness than Comparative Examples 1 and 2.

As can be seen from the foregoing, the multi-layer film according to an embodiment of the present invention exhibits improved heat resistance and high-temperature flatness, thereby facilitating processing carried out at temperatures lower than its glass transition temperature (Tg), and is amenable to processing at temperatures higher than its glass transition temperature (Tg) while inhibiting or completely preventing curling, blocking and sagging phenomena.

While the present invention has been described with respect to the specific embodiments, it will be apparent to those skilled in the art that various changes and modifications may be made without departing from the spirit and scope of the invention as defined in the following claims.

1. A multi-layer film, comprising:
a polymer substrate; and
buffer layers formed on a top surface and a bottom surface of the polymer substrate using a UV-cured and thermally cured product of a UV-curable and thermally curable buffer composition.

2. The multi-layer film according to claim 1, wherein the polymer substrate has a mono-layer structure or a laminated structure comprising two or more polymer layers.

3. The multi-layer film according to claim 1, wherein the polymer substrate comprises at least one selected from a group consisting of a single polymer, a polymer blend of two or more polymers, a polymer composite containing an organic additive, and a polymer composite containing an inorganic additive.

4. The multi-layer film according to claim 3, wherein a polymer of the single polymer or the blend of two or more polymers comprises at least one selected from a group consisting of polynorbornene, aromatic fullerene polyester, polyethersulfone, bisphenol A polysulfone, polyimide, polyethylene terephthalate, polyethylene naphthalene, polyarylate, polycarbonate, and cyclic olefin copolymers.

5. The multi-layer film according to claim 3, wherein the polymer composite containing an inorganic additive is a polymer-clay nanocomposite comprising a clay nanosubstance dispersed in a polymer matrix.

6. The multi-layer film according to claim 1, wherein the buffer layers comprise non-cured epoxy groups in an amount equal to or greater than 10 wt % and less than 100 wt %.

7. The multi-layer film according to claim 1, wherein the buffer layers comprise a UV-cured and thermally cured product of a mixture of hydrolyzate of at least one of an organosilane and a metal alkoxide with a curable epoxy resin.

8. The multi-layer film according to claim 7, wherein the organosilane comprises at least one selected from a group consisting of compounds represented by the following Chemical Formulae 1 to 3, the metal alkoxide comprises at least one selected from a group consisting of compounds represented by the following Chemical Formula 4, and the curable epoxy resin comprises at least one selected from a group consisting of alicyclic epoxy resins, represented by the following Chemical Formulae 5 to 10, and triglycidyl isocyanurates, represented by the following Chemical Formula 11:
(R¹)ₘ—S₁—X₍₄₋ₘ₎ [Chemical Formula 1]
(R¹)ₘ—O—Si—X₍₄₋ₘ₎ [Chemical Formula 2]
(R¹)ₘ—N(R²)—Si—X₍₄₋ₘ₎ [Chemical Formula 3]
wherein X(s) may be the same or different, and each represents H, halogen, a C1-C12 alkoxy, acyloxy, alkylcarbonyl, alkoxycarbonyl or —N(R²)₂;
R¹(s) may be the same or different, and each represents a C1-C12 alkyl, C2-C12 alkenyl, alkynyl, C6-C20 aryl, arylalkyl, alkylaryl, arylalkenyl, alkenylaryl, arylalkynyl, alkynylaryl, halogen, amide, aldehyde, ketone, alkylcarbonyl, carboxy, mercapto, cyano, hydroxyl, C1-C12 alkoxy, C1-C12 alkoxycarbonyl, sulfonic acid, phosphoric acid, acryloxy, methacryloxy, epoxy or vinyl group;
R² is H or C1-C12 alkyl; and
m is an integer of 1-3,
M-(R³)_{z} [Chemical Formula 4]
wherein M is a metal element selected from aluminum, zirconium and titanium;
R³(s) may be the same or different, and each represents halogen or a C1-C12 alkyl, alkoxy, acyloxy or hydroxyl group; and
Z is an integer of 3 or 4, 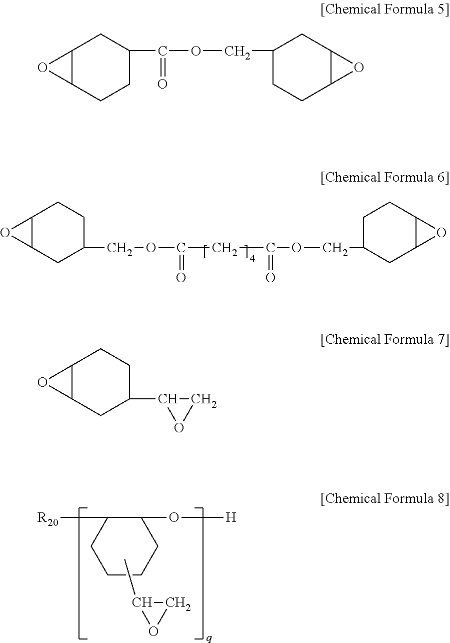
wherein R₂₀ represents alkyl or trimethylolpropane residue, and q is 1-20, 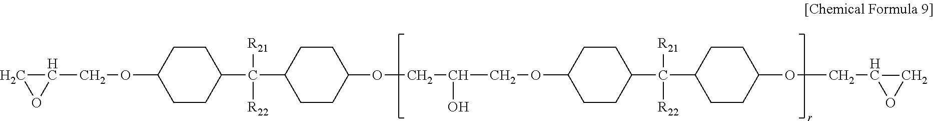
wherein R₂₁ and R₂₂ may be the same or different, and each represents H or CH₃, and r is 0-2, 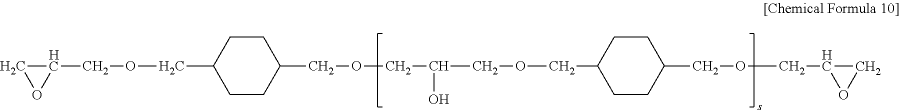
wherein s is 0-2,

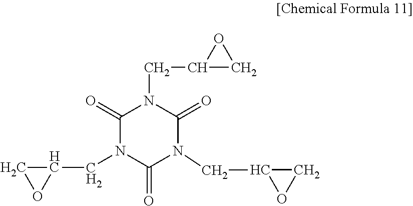

9. The multi-layer film according to claim 7, wherein the hydrolyzate of at least one of organosilane and metal alkoxide is present in an amount of 5-95 parts by weight and the curable epoxy resin is present in an amount of 5-95 parts by weight, based on 100 parts by weight of the cured product.

10. The multi-layer film according to claim 7, wherein the buffer layers further comprise at least one filler selected from a group consisting of metal, glass powder, diamond powder, silicon oxide, clay, calcium phosphate, magnesium phosphate, barium sulfate, aluminum trifluoride, calcium silicate, magnesium silicate, barium silicate, barium carbonate, barium hydroxide and aluminum silicate, a curing agent, a catalyst and a solvent.

11. The multi-layer film according to claim 1, wherein the buffer layers have a thickness of 0.1 μm-50 μm.

12. The multi-layer film according to claim 1, which has a linear expansion coefficient of 5-30 ppm/K.

13. The multi-layer film according to claim 1, which has a pencil hardness of 2H-8H.

14. The multi-layer film according to claim 1, which has a surface roughness (Ra) of 0.1-1.2 nm.

15. A method for producing a multi-layer film, comprising:
(a) coating one surface of a polymer substrate with a UV-curable and thermally curable buffer coating composition to form a buffer layer;
(b) carrying out UV curing of the buffer layer formed in step (a);
(c) coating another surface of the polymer substrate having the buffer layer on one surface thereof with a UV-curable and thermally curable buffer composition to form a buffer layer;
(d) carrying out UV curing of the buffer layer formed in step (c); and
(e) carrying out thermal curing of the UV-cured buffer layers provided on both surfaces of the polymer surface.

16. A method for producing a multi-layer film, comprising:
(a) coating one surface of a polymer substrate with a UV-curable and thermally curable buffer coating composition to form a buffer layer;
(b) carrying out UV curing of the buffer layer;
(c) carrying out thermal curing of the UV-cured buffer layer to form a multi-layer film having a structure comprising the buffer layer laminated with the polymer substrate;
(d) repeating steps (a)-(c) to provide another multi-layer film having the same structure mentioned in step (c); and
(e) laminating the multi-layer films obtained in steps (c) and (d) together, in such a manner that the polymer substrate surfaces thereof are in contact with each other, to form a multi-layer film having a symmetrical structure.

17. The method according to claim 15, wherein the UV curing is carried out under an energy dose ranging from 20 mJ/cm² to 3000 mJ/cm² for a period ranging from 1 second to several hours, and the thermal curing is carried out at a temperature of 100-200° C. for a period ranging from 1 minute to several hours.

18. (canceled)

19. A buffer composition comprising a sol-like composition of hydrolyzate of at least one of an organosilane and a metal alkoxide, and a curable epoxy resin.

20. The buffer composition according to claim 19, wherein the organosilane comprises at least one selected from a group consisting of compounds represented by the following Chemical Formulae 1 to 3, the metal alkoxide comprises at least one selected from a group consisting of compounds represented by the following Chemical Formula 4, and the curable epoxy resin comprises at least one selected from a group consisting of alicyclic epoxy resins represented by the following Chemical Formulae 5 to 10 and triglycidyl isocyanurates represented by the following Chemical Formula 11:
(R¹)ₘ—Si—X₍₄₋ₘ₎ [Chemical Formula 1]
(R¹)ₘ—O—Si—X₍₄₋ₘ₎ [Chemical Formula 2]
(R¹)ₘ—N(R²)—Si—X₍₄₋ₘ₎ [Chemical Formula 3]
wherein X(s) may be the same or different, and each represents H, halogen, a C1-C12 alkoxy, acyloxy, alkylcarbonyl, alkoxycarbonyl or —N(R²)₂;
R¹(s) may be the same or different, and each represents a C1-C12 alkyl, C2-C12 alkenyl, alkynyl, C6-C20 aryl, arylalkyl, alkylaryl, arylalkenyl, alkenylaryl, arylalkynyl, alkynylaryl, halogen, amide, aldehyde, ketone, alkylcarbonyl, carboxy, mercapto, cyano, hydroxyl, C1-C12 alkoxy, C1-C12 alkoxycarbonyl, sulfonic acid, phosphoric acid, acryloxy, methacryloxy, epoxy or vinyl group;
R² is H or C1-C12 alkyl; and
m is an integer of 1-3,
M-(R³)_{z} [Chemical Formula 4]
wherein M is a metal element selected from aluminum, zirconium and titanium;
R³(s) may be the same or different, and each represents halogen, C1-C12 alkyl, alkoxy, acyloxy or hydroxyl group; and
Z is an integer of 3 or 4, 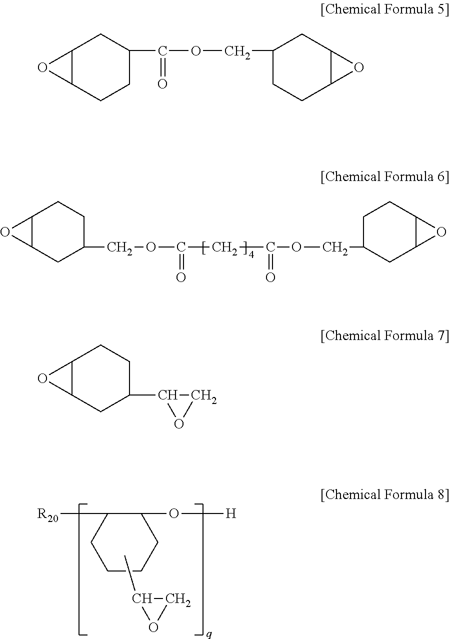
wherein R₂₀ represents alkyl or trimethylolpropane residue, and q is 1-20, 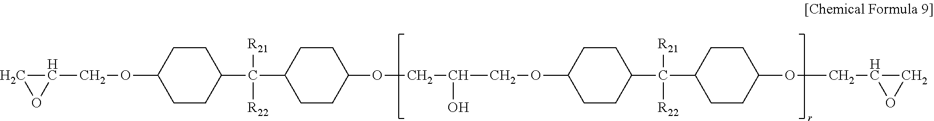
wherein R₂₁ and R₂₂ may be the same or different, and each represents H or CH₃, and r is 0-2, 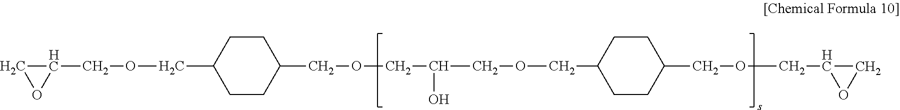
wherein s is 0-2,

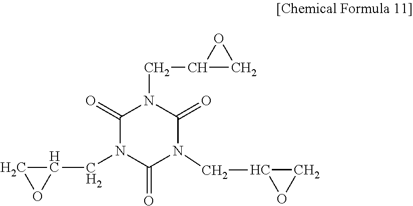

21. An electronic device comprising the multi-layer film defined in claim 1.

22. The method according to claim 16, wherein the UV curing is carried out under an energy dose ranging from 20 mJ/cm² to 3000 mJ/cm² for a period ranging from 1 second to several hours, and the thermal curing is carried out at a temperature of 100-200° C. for a period ranging from 1 minute to several hours.
